(19) United States
(12) Patent Application Publication
(10) Pub. No.: US 2012/0223878 A1
(43) Pub. Date: Sep. 6, 2012

(54) Information Terminal and Portable Information Terminal

(75) Inventor: Shingo SETONO, Daito-shi (JP)

(73) Assignee: Funai Electric Co., Ltd., Daito-shi (JP)

(21) Appl. No.: 13/407,126

(22) Filed: Feb. 28, 2012

(30) Foreign Application Priority Data
Mar. 2, 2011 (JP) 2011-44978

(51) Int. Cl. G09G 5/00

(52) U.S. Cl. 345/156

(57) ABSTRACT

This information terminal includes a control portion displaying a subsequent input item to an input item into which information has been input in a selected state where a user can input information on a display portion on the basis of a prescribed order of a plurality of input items when the user inputs the information into the input item in the selected state where information can be input, of the plurality of input items.

### BACKGROUND OF THE INVENTION

1. Field of the Invention

The present invention relates to an information terminal and a portable information terminal, and more particularly, it relates to an information terminal and a portable information terminal each capable of displaying a plurality of input items.

2. Description of the Background Art

An information terminal capable of displaying a plurality of input items is known in general, as disclosed in Japanese Patent Laying-Open No. 2000-305685, for example.

The aforementioned Japanese Patent Laying-Open No. 2000-305685 discloses a computer (information terminal) including a display portion displaying a plurality of GUI (graphical user interface) elements (input items) to accept information from a user and a processor (control portion) detecting distances between the GUI elements and a mouse pointer. This computer is so formed as to highlight a GUI element as a subsequent input item and control the mouse pointer to move on the GUI element when the user moves the mouse pointer to render a distance between one of the GUI elements and the mouse pointer not more than a prescribed distance. Thus, a burden on the user is reduced when the user inputs information.

In the computer (information terminal) according to the aforementioned Japanese Patent Laying-Open No. 2000-305685, however, the user must select the subsequent GUI element by performing an operation for bringing the mouse pointer close to a GUI element (input item) into which information is input next when inputting information, and hence the user is disadvantageously burdened when inputting information into the input items. Consequently, in the computer (information terminal) according to the aforementioned Japanese Patent Laying-Open No. 2000-305685, a burden on the user cannot be sufficiently reduced when the user inputs information into the input items.

### SUMMARY OF THE INVENTION

The present invention has been proposed in order to solve the aforementioned problem, and an object of the present invention is to provide an information terminal and a portable information terminal each capable of reducing a burden on a user when the user inputs information into a plurality of input items.

An information terminal according to a first aspect of the present invention includes a display portion displaying a plurality of input items to accept information from a user, and a control portion displaying a subsequent input item to an input item into which information has been input in a selected state where the user can input information on the display portion on the basis of a prescribed order of the plurality of input items when the user inputs the information into the input item in the selected state where information can be input, of the plurality of input items.

As hereinabove described, the information terminal according to the first aspect of the present invention is provided with the control portion displaying the subsequent input item to the input item into which the information has been input in the selected state where the user can input information on the display portion on the basis of the prescribed order of the plurality of input items when the user inputs the information into the input item in the selected state where information can be input, of the plurality of input items, whereby the control portion automatically displays the subsequent input item in the selected state where information can be input when the user inputs the information into the input item in the selected state. Consequently, it is not necessary for the user to perform an operation for selecting the subsequent input item, such as moving a mouse pointer. Thus, a burden on the user can be reduced when the user inputs information into the plurality of input items.

In the aforementioned information terminal according to the first aspect, the control portion is preferably so formed as to display the subsequent input item in the selected state where the user can input information on the display portion by displaying a graphical user interface element allowing the user to select or enter information corresponding to the subsequent input item when the user inputs the information into the input item in the selected state, of the plurality of input items. According to this structure, the user can easily input the information into the subsequent input item through the graphical user interface element allowing the user to select or enter the information, and hence a burden on the user can be further reduced.

In this case, the control portion is preferably so formed as to display the subsequent input item in the selected state where the user can input information on the display portion by moving the subsequent input item into a display area of the display portion if the subsequent input item is located outside the display area of the display portion, when the user inputs the information into the input item in the selected state, of the plurality of input items. According to this structure, the control portion automatically moves the subsequent input item into the display area even if the subsequent input item is located outside the display area, and hence it is not necessary for the user to perform an operation for moving the subsequent input item into the display area, such as scrolling a screen. Consequently, a burden on the user can be suppressed even if the subsequent input item is located outside the display area. This effect is particularly effective for a portable information terminal including a small-sized display portion on which all of the input items cannot be displayed due to a small screen.

In the aforementioned structure of displaying the graphical user interface element allowing the user to select or enter the information, the graphical user interface element allowing the user to select the information corresponding to the subsequent input item preferably includes a select list of the information corresponding to the subsequent input item, and the graphical user interface element allowing the user to enter the information corresponding to the subsequent input item preferably includes a cursor allowing the user to enter character information corresponding to the subsequent input item. According to this structure, the user can easily input the information into the subsequent input item simply by selecting desired information from the select list, and can easily input the character information into the subsequent input item simply by entering the character information in a position where the cursor is displayed.

In the aforementioned structure of displaying the graphical user interface element allowing the user to select or enter the information, the control portion is preferably so formed as to display a graphical user interface element allowing the user to select or enter information corresponding to an input item having previously been in the selected state on a second display area different from a first display area displaying the plurality of input items and display the subsequent input item in the selected state where the user can input information on the display portion, when the user inputs the information into the input item in the selected state, of the plurality of input items. According to this structure, the graphical user interface element corresponding to the input item having previously been in the selected state is displayed, and hence the user can easily reenter information in the input item having previously been in the selected state through the graphical user interface element.

In the aforementioned structure of displaying the graphical user interface element corresponding to the input item having previously been in the selected state on the second display area, the control portion is preferably so formed as to display the graphical user interface element allowing the user to select or enter the information corresponding to the subsequent input item on a third display area different from the first display area and the second display area when the user inputs the information into the input item in the selected state, of the plurality of input items. According to this structure, the user can easily input information into both the input item having previously been in the selected state and the subsequent input item through the graphical user interface elements.

In the aforementioned structure of displaying the graphical user interface element corresponding to the subsequent input item on the third display area, the second display area and the third display area are preferably arranged adjacent to each other. According to this structure, the second display area and the third display area can be arranged close to each other, and hence operating ranges for the input item having previously been in the selected state and the subsequent input item can be reduced. Consequently, a burden on an operation of the user can be reduced when the user inputs information.

In the aforementioned structure of displaying the graphical user interface element corresponding to the input item having previously been in the selected state on the second display area, the control portion is preferably so formed as to accept change in information having been input into the input item having previously been in the selected state when the user inputs information through the graphical user interface element corresponding to the input item having previously been in the selected state, displayed on the second display area. According to this structure, the user can easily change the information having been input into the input item having previously been in the selected state simply by inputting information through the graphical user interface element displayed on the second display area.

In the aforementioned structure of displaying the graphical user interface element corresponding to the input item having previously been in the selected state on the second display area, information other than information having been selected by the user is preferably selectably displayed in the graphical user interface element allowing the user to select the information corresponding to the input item having previously been in the selected state, displayed on the second display area. According to this structure, the information having been selected by the user, corresponding to the input item having previously been in the selected state is not displayed, and hence the information (options) other than the information having been selected by the user can be more plentifully displayed in the limited second display area.

In the aforementioned information terminal according to the first aspect, the control portion is preferably so formed as to move the subsequent input item to a vicinity of a central portion of a display area displaying the plurality of input items when the user inputs the information into the input item in the selected state, of the plurality of input items. According to this structure, the subsequent input item is displayed in the vicinity of the central portion, which is the most noticeable in the display area, and hence the user can easily recognize the subsequent input item.

In the aforementioned information terminal according to the first aspect, the control portion is preferably so formed as to display the subsequent input item in the selected state where the user can input information and in a state distinguishable from other input items on the display portion when the user inputs the information into the input item in the selected state, of the plurality of input items. According to this structure, the user can easily recognize the subsequent input item from among the plurality of input items.

In the aforementioned structure having the graphical user interface element including the select list, the control portion is preferably so formed as to display the select list on the display portion such that the select list overlaps a display area of the subsequent input item. According to this structure, the user can easily recognize which one of the plurality of input items corresponds to the select list. Furthermore, the select list overlaps the display area of the subsequent input item so that the display area of the select list can be increased, whereby more options can be displayed in the select list.

A portable information terminal according to a second aspect of the present invention includes a display portion having such a size that part of a plurality of input items to accept information from a user can be displayed on a same screen, and a control portion displaying a subsequent input item to an input item into which information has been input in a selected state where the user can input information on the display portion on the basis of a prescribed order of the plurality of input items when the user inputs the information into the input item in the selected state where information can be input, of the plurality of input items.

As hereinabove described, the portable information terminal according to the second aspect of the present invention is provided with the control portion displaying the subsequent input item to the input item into which the information has been input in the selected state where the user can input information on the display portion on the basis of the prescribed order of the plurality of input items when the user inputs the information into the input item in the selected state where information can be input, of the plurality of input items, whereby the control portion automatically displays the subsequent input item in the selected state where information can be input when the user inputs the information into the input item in the selected state. Consequently, it is not necessary for the user to perform an operation for selecting the subsequent input item, such as moving a mouse pointer. Thus, a burden on the user can be reduced when the user inputs information into the plurality of input items. Furthermore, the present invention enabling reduction in a burden on the user by reducing user operations on a display screen is more effective for the portable information terminal including the small-sized display portion on which only part of the plurality of input items can be displayed on the same screen.

In the aforementioned portable information terminal according to the second aspect, the control portion is preferably so formed as to display the subsequent input item in the selected state where the user can input information on the display portion by displaying a graphical user interface element allowing the user to select or enter information corresponding to the subsequent input item when the user inputs the information into the input item in the selected state, of the plurality of input items. According to this structure, the user can easily input the information into the subsequent input item through the graphical user interface element allowing the user to select or enter the information, and hence a burden on the user can be further reduced.

In this case, the control portion is preferably so formed as to display the subsequent input item in the selected state where the user can input information on the display portion by moving the subsequent input item into a display area of the display portion if the subsequent input item is located outside the display area of the display portion, when the user inputs the information into the input item in the selected state, of the plurality of input items. According to this structure, the control portion automatically moves the subsequent input item into the display area even if the subsequent input item is located outside the display area, and hence it is not necessary for the user to perform an operation for moving the subsequent input item into the display area, such as scrolling a screen. Consequently, a burden on the user can be suppressed even if the subsequent input item is located outside the display area. This effect is particularly effective for the portable information terminal including the small-sized display portion on which all of the input items cannot be displayed due to a small screen.

In the aforementioned structure of displaying the graphical user interface element allowing the user to select or enter the information, the graphical user interface element allowing the user to select the information corresponding to the subsequent input item preferably includes a select list of the information corresponding to the subsequent input item, and the graphical user interface element allowing the user to enter the information corresponding to the subsequent input item preferably includes a cursor allowing the user to enter character information corresponding to the subsequent input item. According to this structure, the user can easily input the information into the subsequent input item simply by selecting desired information from the select list, and can easily input the character information into the subsequent input item simply by entering the character information in a position where the cursor is displayed.

In the aforementioned structure of displaying the graphical user interface element allowing the user to select or enter the information, the control portion is preferably so formed as to display a graphical user interface element allowing the user to select or enter information corresponding to an input item having previously been in the selected state on a second display area different from a first display area displaying the plurality of input items and display the subsequent input item in the selected state where the user can input information on the display portion, when the user inputs the information into the input item in the selected state, of the plurality of input items. According to this structure, the graphical user interface element corresponding to the input item having previously been in the selected state is displayed, and hence the user can easily reenter information in the input item having previously been in the selected state through the graphical user interface element.

In the aforementioned structure of displaying the graphical user interface element corresponding to the input item having previously been in the selected state on the second display area, the control portion is preferably so formed as to display the graphical user interface element allowing the user to select or enter the information corresponding to the subsequent input item on a third display area different from the first display area and the second display area when the user inputs the information into the input item in the selected state, of the plurality of input items. According to this structure, the user can easily input information into both the input item having previously been in the selected state and the subsequent input item through the graphical user interface elements.

In the aforementioned structure of displaying the graphical user interface element corresponding to the input item having previously been in the selected state on the second display area, information other than information having been selected by the user is preferably selectably displayed in the graphical user interface element allowing the user to select the information corresponding to the input item having previously been in the selected state, displayed on the second display area. According to this structure, the information having been selected by the user, corresponding to the input item having previously been in the selected state is not displayed, and hence the information (options) other than the information having been selected by the user can be more plentifully displayed in the limited second display area.

In the aforementioned portable information terminal according to the second aspect, the control portion is preferably so formed as to move the subsequent input item to a vicinity of a central portion of a display area displaying the plurality of input items when the user inputs the information into the input item in the selected state, of the plurality of input items. According to this structure, the subsequent input item is displayed in the vicinity of the central portion, which is the most noticeable in the display area, and hence the user can easily recognize the subsequent input item.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front elevational view showing a smartphone according to each of first and second embodiments of the present invention;

FIG. 2 is a block diagram showing the structure of the smartphone according to each of the first and second embodiments of the present invention;

FIG. 3 is a diagram showing the smartphone displaying a web page, according to each of the first and second embodiments of the present invention;

FIG. 4 is a diagram showing the overall web page capable of being displayed by the smartphone according to each of the first and second embodiments of the present invention;

FIG. 5 is a flowchart for illustrating processing for inputting information in the smartphone according to the first embodiment of the present invention;

FIG. 6 is a diagram showing a screen on which a combo box for day of check-in is in a selected state in the smartphone according to the first embodiment of the present invention;

FIG. 7 is a diagram showing a screen on which a text box for a coupon number is in the selected state in the smartphone according to the first embodiment of the present invention;

FIG. 8 is a diagram showing a screen on which a combo box for month of check-out is in the selected state in the smartphone according to the first embodiment of the present invention;

FIG. 9 is a diagram showing a screen on which a combo box for room rates is in the selected state in the smartphone according to the first embodiment of the present invention;

FIG. 10 is a diagram showing a screen on which a combo box for the number of persons per room is in the selected state in the smartphone according to the first embodiment of the present invention;

FIG. 11 is a diagram showing a screen on which a combo box for room rates is in a selected state in the smartphone according to the second embodiment of the present invention;

FIG. 12 is a diagram showing a screen on which a combo box for the number of persons per room is in the selected state in the smartphone according to the second embodiment of the present invention;

FIG. 13 is a diagram showing a screen on which a text box for a coupon number is in the selected state in the smartphone according to the second embodiment of the present invention;

FIG. 14 is a flowchart for illustrating processing for inputting information in the smartphone according to the second embodiment of the present invention; and

FIG. 15 is a flowchart for illustrating processing for inputting information in the smartphone according to a modification of the first embodiment of the present invention.

### DESCRIPTION OF THE PREFERRED EMBODIMENTS

Embodiments of the present invention are now described with reference to the drawings.

### First Embodiment

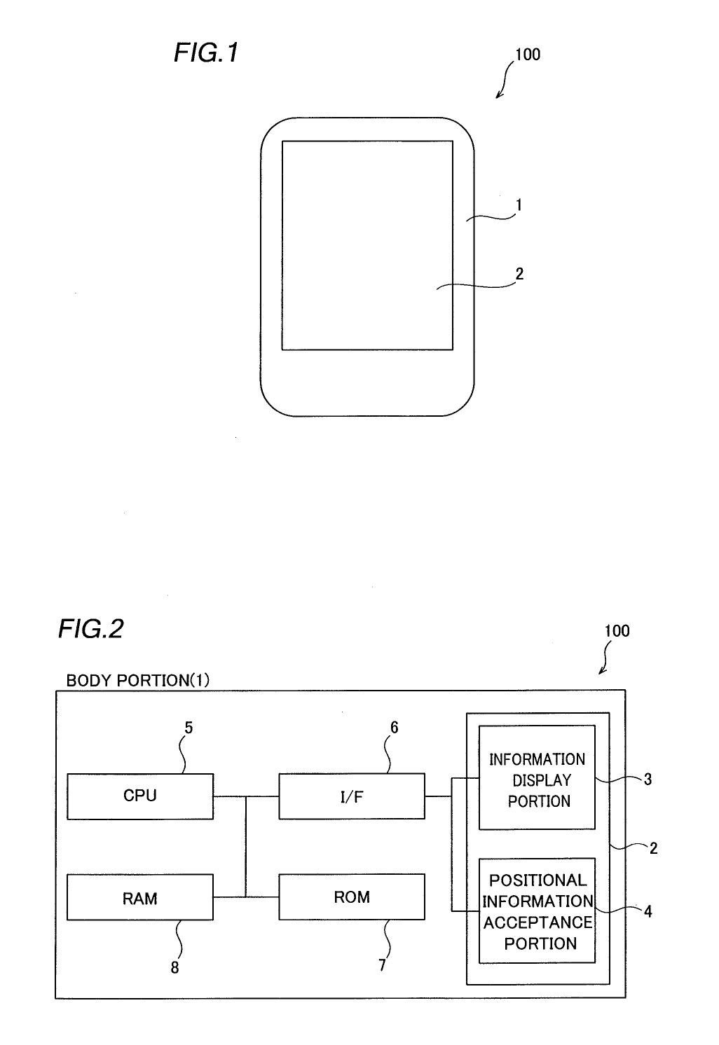

First, the structure of a smartphone 100 according to a first embodiment of the present invention is described with reference to FIGS. 1 to 4. The smartphone 100 is examples of the “information terminal” and the “portable information terminal” in the present invention.

The smartphone 100 according to the first embodiment of the present invention includes a body portion 1 having a substantially rectangular shape in front elevational view and a touch panel display portion 2 arranged on the front side of the body portion 1, as shown in FIG. 1. Furthermore, inside the body portion 1 of the smartphone 100, an information display portion 3 to display information such as characters and images on the display portion 2, a positional information acceptance portion 4 accepting positional information on a touch panel indicated by a user, and a CPU 5 controlling each portion are provided, as shown in FIG. 2. The CPU 5 is an example of the “control portion” in the present invention.

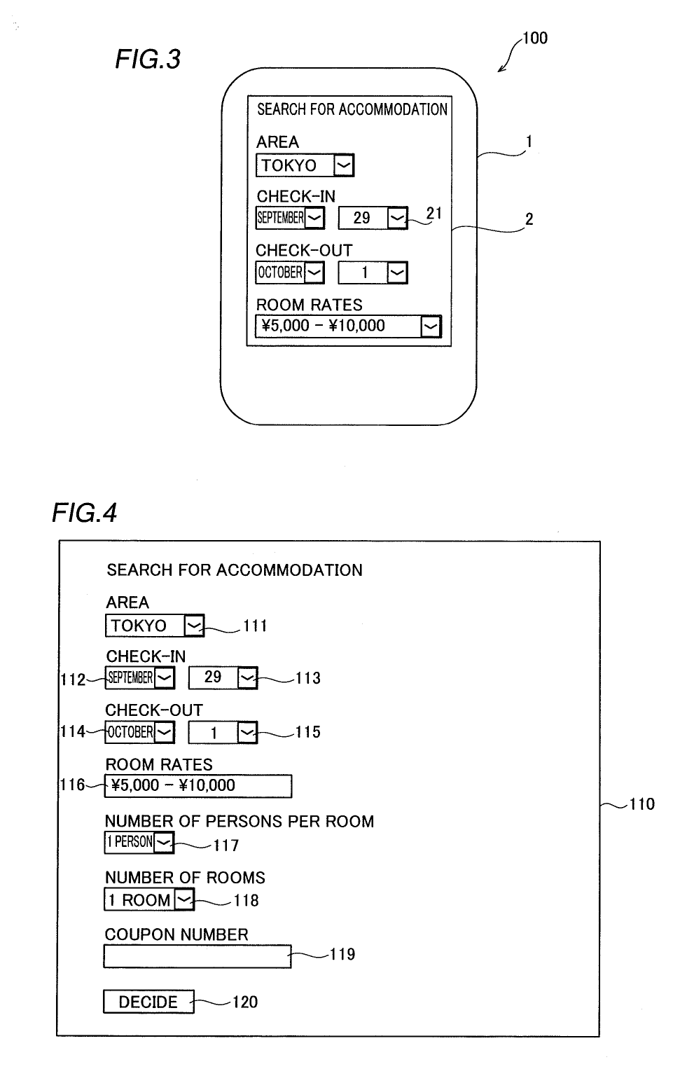

The display portion 2 has a substantially rectangular shape, as shown in FIG. 1. The display portion 2 is so formed as to be capable of displaying a web page described by HTML (HyperText Markup Language). More specifically, the display portion 2 is so formed as to be capable of displaying a web page for a PC (personal computer) screen 110 (see FIG. 4) described by HTML, as shown in FIG. 3. The display area of the display portion 2 is smaller than that of the PC screen 110, and hence the display portion 2 is so formed as to display only part of a displayable range of the PC screen 110. In the case of a web page containing a plurality of input items (combo boxes 111 to 118 and a text box 119) such as a search page for accommodation shown in FIG. 4, for example, only part of the plurality of input items capable of being displayed on the PC screen 110 is displayed on the display portion 2, as shown in FIG. 3.

The information display portion 3 and the positional information acceptance portion 4 are connected to the CPU 5 through an I/F (interface) 6, as shown in FIG. 2. The information display portion 3 and the positional information acceptance portion 4 are provided in the display portion 2 while overlapping each other.

The CPU 5 is so formed as to execute various types of processing by running programs stored in a ROM 7. The CPU 5 is so formed as to temporarily store information in a RAM 8 when executing various types of processing.

Next, processing for inputting information executed by the CPU 5 of the smartphone 100 according to the first embodiment of the present invention is described with reference to FIGS. 3 to 10.

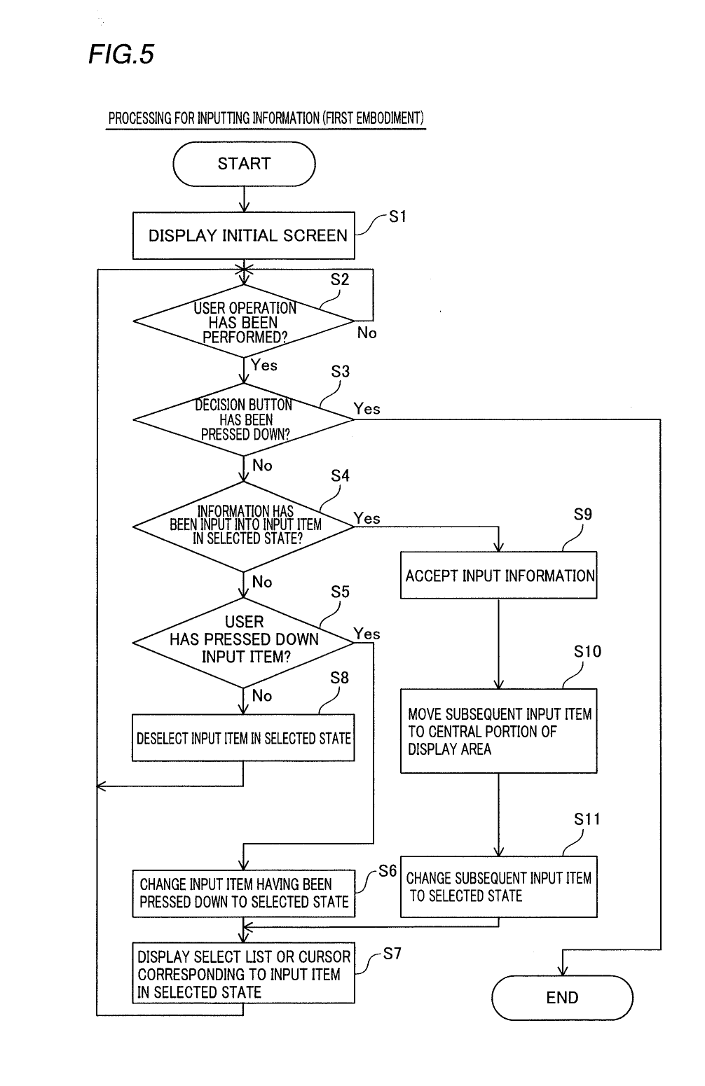

First, at a step S1 in FIG. 5, the CPU 5 controls the display portion 2 to display an initial screen, as shown in FIG. 3. Then, the CPU 5 determines whether or not a user operation has been performed at a step S2 and repeats this determination until a user operation is performed. If determining that a user operation has been performed, the CPU 5 determines whether or not the operation is to press down a decision button 120 (see FIG. 4) at a step S3. If determining that the decision button 120 has been pressed down, the CPU 5 terminates the processing for inputting information. When the decision button 120 is pressed down on a search screen for accommodation according to the first embodiment, display on the display portion 2 changes from the search screen for accommodation to another web page.

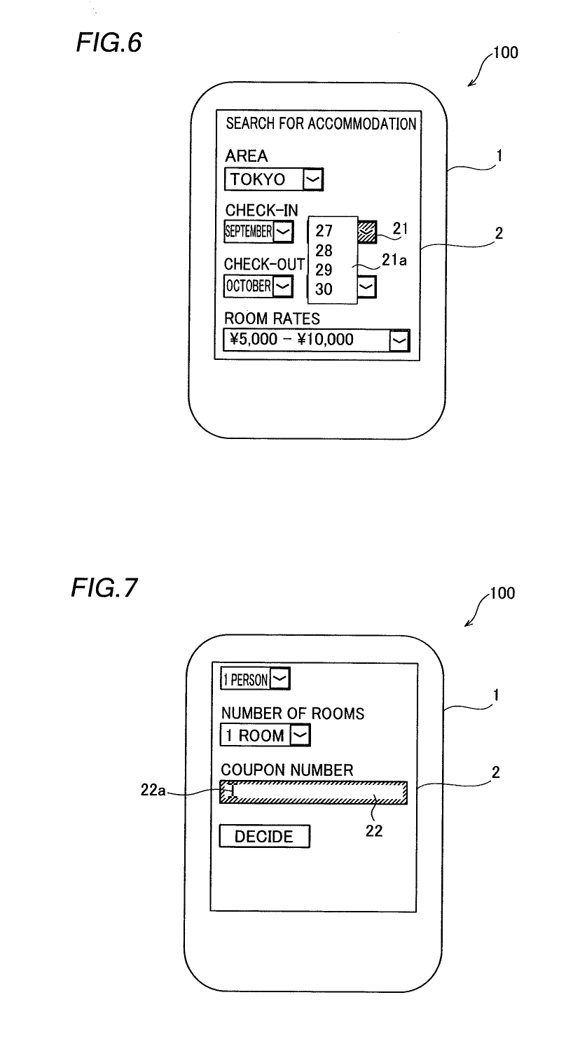

If determining that the user operation is not to press down the decision button 120, the CPU 5 determines whether or not the user operation is to input information into an input item in a selected state at a step S4. Here, the input item in the selected state is an input item (combo box and text box) in a state where information can be input, and according to the first embodiment, only one of the plurality of input items is in the selected state. In other words, two or more input items are not simultaneously in the selected state. Furthermore, according to the first embodiment, the input item in the selected state is color-coded to be highlighted in order to be distinguishable from other input items, as shown in FIGS. 6 to 10. On the initial screen, none of the input items is in the selected state, as shown in FIG. 3. If a user operation is performed on the initial screen, therefore, the CPU 5 determines that information has not been input into the input item in the selected state at the step S4, and advances to a step S5.

Then, the CPU 5 determines whether or not the user operation is to press down (select) one of the input items at the step S5. If the user presses down (selects) one of the input items, the CPU 5 changes the input item pressed down (selected) by the user to the selected state at a step S6. Specifically, the CPU 5 changes a combo box 21 (input item) for day of check-in to the selected state and highlights the same, as shown in FIG. 6 if the user presses down (selects) the combo box 21 on the initial screen shown in FIG. 3. At a step S7, the CPU 5 displays a select list corresponding to the input item in the selected state or a cursor allowing the user to enter character information corresponding to the input item in the selected state. In an example shown in FIG. 6, a select list 21a corresponding to the combo box 21 for day of check-in in the selected state is displayed to overlap part of the combo box 21. As shown in FIG. 7, a cursor 22a allowing the user to enter character information in a text box 22 is displayed when the text box 22 is in the selected state.

If the user has not pressed down one of the input items, the CPU 5 deselects the input item in the selected state at a step S8. In other words, the CPU 5 advances to the step S8 and deselects the input item in the selected state if the user operation is not to press down the decision button 120 (see FIG. 4), to input information into the input item in the selected state, or to press down (select) one of the input items. Thus, none of the input items is in the selected state. An exemplary user operation for advancing to the step S8 is to touch space in the search page for accommodation other than the input items and the decision button 120 (see FIG. 4).

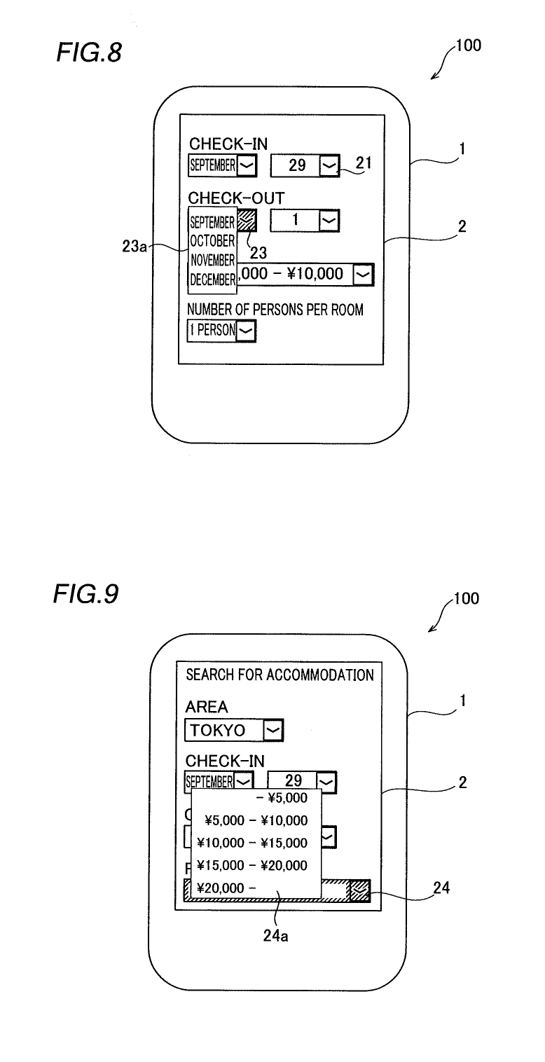

If determining that information has been input into the input item in the selected state at the step S4, the CPU 5 accepts the input information at a step S9. If the user selects (inputs) “29” as day of check-in from the select list 21a in FIG. 6, for example, the CPU 5 displays “29” in the combo box 21 for day of check-in, as shown in FIG. 8. At a step S10, the CPU 5 moves a subsequent input item to the central portion of the display area. In other words, the CPU 5 moves a display range of the search page for accommodation to display the subsequent input item on the central portion of the display area. Specifically, the CPU 5 moves a combo box 23 for month of check-out as the subsequent input item to the central portion of the display area, as shown in FIG. 8 if the user has input information into the combo box 21 (input item) for day of check-in shown in FIG. 6. According to the first embodiment, the CPU 5 determines the subsequent input item on the basis of the description order of HTML of the web page.

At a step S11, the CPU 5 changes the subsequent input item (combo box 23 in an example shown in FIG. 8) located on the central portion of the display area to the selected state and highlights the same. Then, the CPU 5 displays a select list corresponding to the input item in the selected state or a cursor allowing the user to enter character information corresponding to the input item in the selected state at the step S7. In the example shown in FIG. 8, a select list 23a corresponding to the combo box 23 for month of check-out in the selected state is displayed to overlap part of the combo box 23.

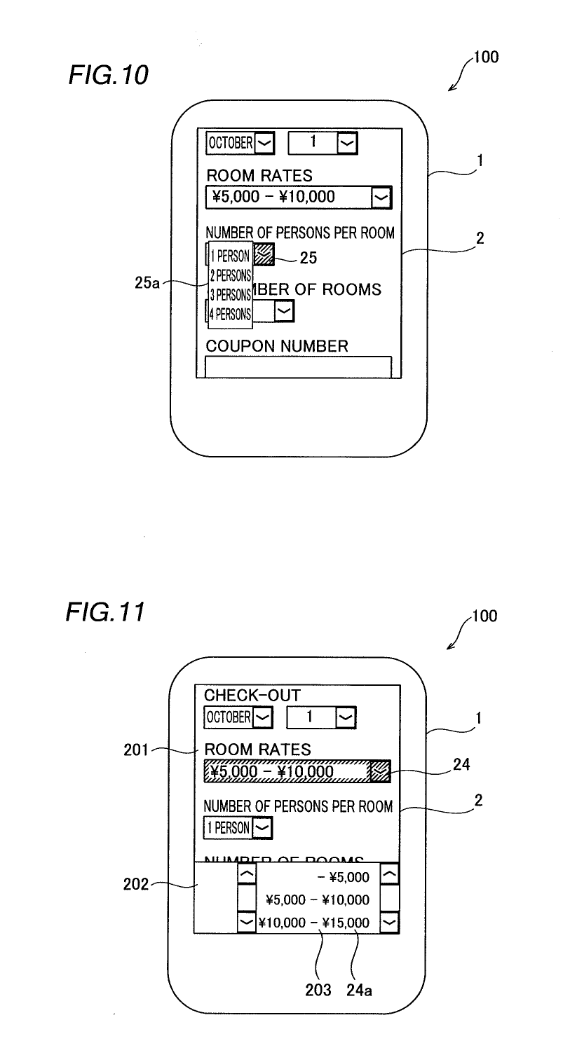

According to the first embodiment, even if the input item subsequent to the input item, information of which has been accepted, is not located inside the display area (is located outside the display area), the CPU 5 moves the display range to locate the subsequent input item on the central portion of the display area and changes the subsequent input item to the selected state at the steps S9 to S11, similarly to a case where the subsequent input item is located inside the display area. Specifically, if information has been input into a combo box 24 for room rates located on the lower portion of the display area (information has been selected from a select list 24a), as shown in FIG. 9, the subsequent input item (combo box 25 for the number of persons per room) located outside the display area is moved to the central portion of the display area, as shown in FIG. 10. Then, the CPU 5 highlights the subsequent input item (combo box 25 for the number of persons per room) and displays a select list 25a corresponding to the subsequent input item, similarly to the example in FIG. 8.

According to the first embodiment, as hereinabove described, the smartphone 100 is provided with the CPU 5 displaying the subsequent input item in the selected state where the user can input information on the display portion 2 when the user inputs information into the input item in the selected state where information can be input, of the plurality of input items. Thus, the CPU 5 automatically displays the subsequent input item in the selected state where information can be input when the user inputs the information into the input item in the selected state, and hence it is not necessary for the user to perform an operation for selecting the subsequent input item, such as moving the mouse pointer. Thus, a burden on the user can be reduced when the user inputs information into the plurality of input items. Furthermore, the present invention enabling reduction in a burden on the user by reducing user operations on a display screen is more effective for the smartphone 100 according to the first embodiment including the small-sized display portion 2 on which only part of the plurality of input items can be displayed on the same screen.

According to the first embodiment, the CPU 5 is so formed as to display the subsequent input item in the selected state where the user can input information on the display portion 2 by displaying the select list allowing the user to select information corresponding to the subsequent input item or the cursor allowing the user to enter character information corresponding to the subsequent input item when the user inputs information into the input item in the selected state. According to this structure, the user can easily input the information into the subsequent input item simply by selecting desired information from the select list, and can easily input the character information into the subsequent input item simply by entering the character information in a position where the cursor is displayed.

According to the first embodiment, the CPU 5 is so formed as to display the subsequent input item in the selected state where the user can input information on the display portion 2 by moving the subsequent input item into the display area of the display portion 2 if the subsequent input item is located outside the display area of the display portion 2 when the user inputs information into the input item in the selected state. According to this structure, the CPU 5 automatically moves the subsequent input item into the display area even if the subsequent input item is located outside the display area, and hence it is not necessary for the user to perform an operation for moving the subsequent input item into the display area, such as scrolling the screen. Consequently, a burden on the user can be suppressed even if the subsequent input item is located outside the display area. This effect is particularly effective for the smartphone 100 according to the first embodiment including the small-sized display portion 2 on which all of the input items cannot be displayed due to a small screen.

According to the first embodiment, the CPU 5 is so formed as to move the subsequent input item to the central portion of the display area in which the plurality of input items are displayed when the user inputs information into the input item in the selected state. According to this structure, the subsequent input item is displayed on the central portion, which is the most noticeable in the display area, and hence the user can easily recognize the subsequent input item.

According to the first embodiment, the CPU 5 displays the subsequent input item in a state distinguishable from other input items on the display portion 2. According to this structure, the user can easily recognize the subsequent input item from among the plurality of input items.

According to the first embodiment, the CPU 5 displays the select list on the display portion 2 while the select list overlaps the display area of the subsequent input item. According to this structure, the user can easily recognize which one of the plurality of input items corresponds to the select list. Furthermore, the select list overlaps the display area of the subsequent input item so that the display area of the select list can be increased, whereby more options can be displayed in the select list.

### Second Embodiment

A second embodiment is now described. In this second embodiment, a select list corresponding to an input item in a selected state or a cursor allowing a user to enter character information corresponding to the input item in the selected state is displayed while a select list corresponding to an input item having previously been in the selected state or a cursor allowing the user to enter character information corresponding to the input item having previously been in the selected state is displayed, dissimilarly to the aforementioned first embodiment.

According to the second embodiment, a CPU 5 is so formed as to divide the overall display area of a display portion 2 into three display areas of a first display area 201, a second display area 202, and a third display area 203 when any one of input items is in the selected state, as shown in FIGS. 11 to 13. The first display area 201 is arranged on a portion (portion including a central portion and an upper portion) of the overall display area of the display portion 2 excluding a lower portion. The second display area 202 is arranged on the lower left portion of the overall display area of the display portion 2, and the third display area 203 is arranged on the lower right portion of the overall display area of the display portion 2. In other words, the second display area 202 and the third display area 203 are arranged adjacent to each other.

Processing for inputting information executed by the CPU 5 of a smartphone 100 according to the second embodiment of the present invention is now described with reference to FIGS. 11 to 14.

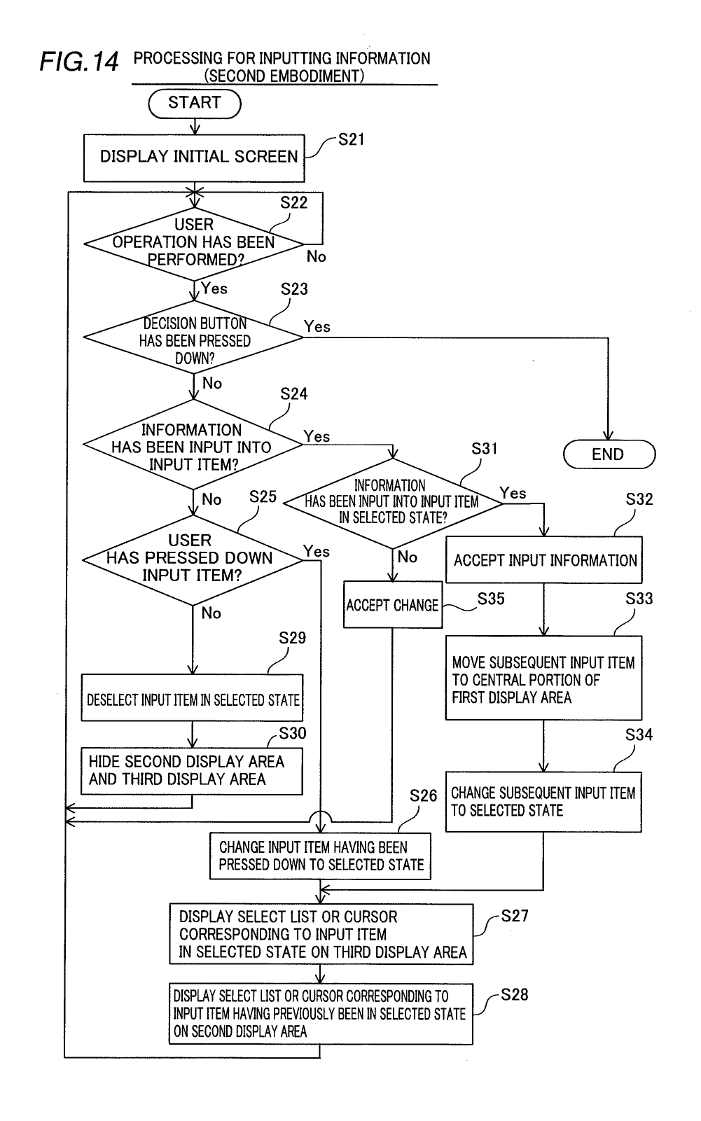

Steps S21 to S23 in FIG. 14 are similar to the steps S1 to S3 (see FIG. 5) in the aforementioned first embodiment, respectively, and hence the description is omitted. After the step S23, the CPU 5 determines whether or not a user operation is to input information into one of the input items at a step S24. If determining that the user operation is not to input information into one of the input items, the CPU 5 performs steps S25 and S26 similarly to the steps S5 and S6 in the aforementioned first embodiment, respectively.

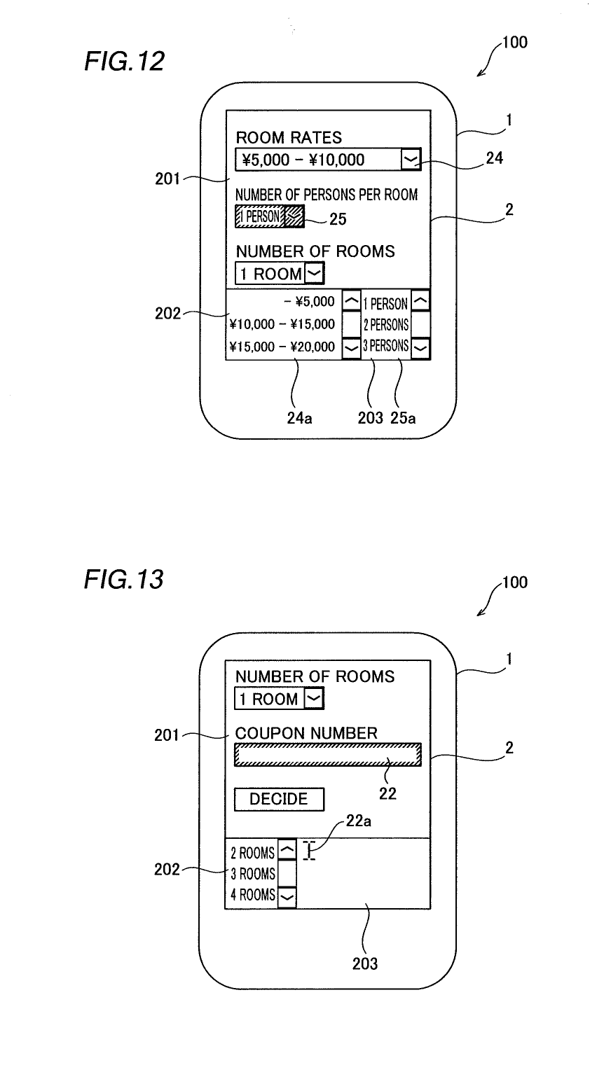

According to the second embodiment, the CPU 5 displays the select list corresponding to the input item in the selected state or the cursor allowing the user to enter character information corresponding to the input item in the selected state on the third display area 203 at a step S27 after changing the input item to the selected state at the step S26. Then, the CPU 5 displays the select list corresponding to the input item having previously been in the selected state or the cursor allowing the user to enter character information corresponding to the input item on the second display area 202 at a step S28. At this time, a plurality of input items are displayed on the first display area 201. If the user presses down (selects) a combo box 24 (input item) for room rates, for example, a select list 24a corresponding to the combo box 24 for room rates is displayed on the third display area 203, as shown in FIG. 11. At this time, the second display area 202 is blank, as shown in FIG. 11 if there is no input item having previously been in the selected state. If there is the input item having previously been in the selected state, a select list 25a corresponding to the input item (combo box 25 for the number of persons per room) in the selected state is displayed on the third display area 203 while the select list 24a of the input item (combo box 24 for room rates) having previously been in the selected state is displayed on the second display area 202, as in an example shown in FIG. 12. If the second display area 202 and the third display area 203 are not displayed (see FIG. 3), the CPU 5 divides the display area into the three areas to prepare the second display area 202 and the third display area 203, and thereafter performs the steps S27 and S28.

If the user operation is not to press down a decision button 120 (see FIG. 4), to input information into one of the input items, or to press down (select) one of the input items, the CPU 5 advances to a step S29 and deselects the input item in the selected state. Thus, none of the input items is in the selected state. The CPU 5 hides the second display area 202 and the third display area 203 at a step S30. Thus, the divided display areas of the display portion 2 are integrated to display a plurality of input items on the overall display area of the display portion 2, as shown in FIG. 3.

If determining that information has been input into one of the input items at the step S24, the CPU 5 determines whether or not the user operation is to input information into the input item in the selected state at a step S31. If determining that the user operation is to input information into the input item in the selected state, the CPU 5 accepts the input information at a step S32. Then, the CPU 5 moves a subsequent input item to the central portion of the first display area 201 at a step S33. Specifically, the CPU 5 moves the combo box 25 for the number of persons per room as the subsequent input item to the central portion of the first display area 201, as shown in FIG. 12 if information has been input into the combo box 24 (input item) for room rates shown in FIG. 11.

The CPU 5 changes the subsequent input item (combo box 25 in the example shown in FIG. 12) located on the central portion of the first display area 201 to the selected state and highlights the same at a step S34. Furthermore, the CPU 5 displays the select list corresponding to the input item in the selected state or the cursor allowing the user to enter character information corresponding to the input item in the selected state on the third display area 203 at the step S27, and displays the select list corresponding to the input item having previously been in the selected state or the cursor allowing the user to enter character information corresponding to the input item having previously been in the selected state on the second display area 202 at the step S28. In the example shown in FIG. 12, the select list 25a corresponding to the combo box 25 for the number of persons per room in the selected state is displayed on the third display area 203 while the select list 24a corresponding to the combo box 24 for room rates having previously been in the selected state is displayed on the second display area 202. At this time, only information other than information having been selected by the user is included in the select list displayed on the second display area 202. In other words, in the example shown in FIG. 12, an option “¥5,000-¥10,000” is not displayed on the second display area 202 if “¥5,000-¥10,000” is selected in the combo box 24 for room rates as the input item having previously been in the selected state. The user employs the select list displayed on the second display area 202 to change the input information to other information (another option), and hence it is not necessary to display the selected information on the second display area 202. If the input in the selected state is a text box 22 into which character information is input, a cursor 22a allowing the user to enter character information is displayed on the third display area 203, as shown in FIG. 13.

If the user has input information into the input item having previously been in the selected state, on the other hand, the CPU 5 accepts the input information (modified information) at a step S35 after the step S31.

The remaining structure of the smartphone 100 according to the second embodiment is similar to that of the smartphone 100 according to the aforementioned first embodiment.

According to the second embodiment, the CPU 5 displays the subsequent input item in the selected state where the user can input information on the display portion 2 when the user inputs information into the input item in the selected state, similarly to the aforementioned first embodiment, whereby it is not necessary for the user to perform an operation for selecting the subsequent input item so that a burden on the user can be reduced.

According to the second embodiment, as hereinabove described, the CPU 5 displays the select list allowing the user to select information corresponding to the input item having previously been in the selected state or the cursor allowing the user to enter character information corresponding to the input item having previously been in the selected state on the second display area 202 when the user inputs information into the input item in the selected state. According to this structure, the select list allowing the user to select information corresponding to the input item having previously been in the selected state or the cursor allowing the user to enter character information corresponding to the input item having previously been in the selected state is displayed, and hence the user can easily reenter information in the input item having previously been in the selected state using the select list or the cursor.

According to the second embodiment, the CPU 5 is so formed as to display the select list allowing the user to select information corresponding to the subsequent input item or the cursor allowing the user to enter character information corresponding to the subsequent input item on the third display area 203. According to this structure, the user can easily input information into both the input item having previously been in the selected state and the subsequent input item using the select lists and the cursors.

According to the second embodiment, the second display area 202 and the third display area 203 are arranged adjacent to each other. According to this structure, the second display area 202 and the third display area 203 can be arranged close to each other, and hence operating ranges for the input item having previously been in the selected state and the subsequent input item can be reduced. Consequently, a burden on an operation of the user can be reduced when the user inputs information.

According to the second embodiment, the CPU 5 is so formed as to accept change in information input into the input item having previously been in the selected state when the user inputs information using the select list or the cursor corresponding to the input item having previously been in the selected state, displayed on the second display area 202. According to this structure, the user can easily change the information having been input into the input item having previously been in the selected state simply by inputting information using the select list or the cursor displayed on the second display area 202.

According to the second embodiment, the CPU 5 is so formed as to selectably display the information other than the information having been selected by the user in the select list allowing the user to select the information corresponding to the input item having previously been in the selected state, displayed on the second display area 202. According to this structure, the information having been selected by the user, corresponding to the input item having previously been in the selected state is not displayed, and hence the information (options) other than the information having been selected by the user can be more plentifully displayed in the limited second display area 202.

The remaining effects of the second embodiment are similar to those of the aforementioned first embodiment.

Although the present invention has been described and illustrated in detail, it is clearly understood that the same is by way of illustration and example only and is not to be taken by way of limitation, the spirit and scope of the present invention being limited only by the terms of the appended claims.

For example, while the smartphone is employed as examples of the information terminal and the portable information terminal in each of the aforementioned first and second embodiments, the present invention is not restricted to this. In the present invention, a portable information terminal other than the smartphone, such as a PDA (personal digital assistant) or a notebook computer may alternatively be employed. Furthermore, the present invention may be applied to not only the portable information terminal but also a stationary PC (personal computer).

While the CPU serving as the control portion is so formed as to determine the subsequent input item on the basis of the description order of HTML in each of the aforementioned first and second embodiments, the present invention is not restricted to this. In the present invention, the control portion may alternatively be so formed as to determine the subsequent input item on the basis of an order preset by the user or another order other than the description order of HTML and the order preset by the user.

While the touch panel display portion is employed as an example of the display portion in each of the aforementioned first and second embodiments, the present invention is not restricted to this. In the present invention, a display portion in which a user inputs information using a mouse, a keyboard, or the like, other than the touch panel display portion may alternatively be employed, for example.

While the CPU serving as the control portion is so formed as to move the subsequent input item to the central portion of the display area regardless of whether or not the subsequent input item is located outside the display area in the aforementioned first embodiment, the present invention is not restricted to this. In the present invention, the CPU may alternatively be so formed as not to move the subsequent input item to the central portion of the display area, but to move the subsequent input item into the display area only when the subsequent input item is located outside the display area.

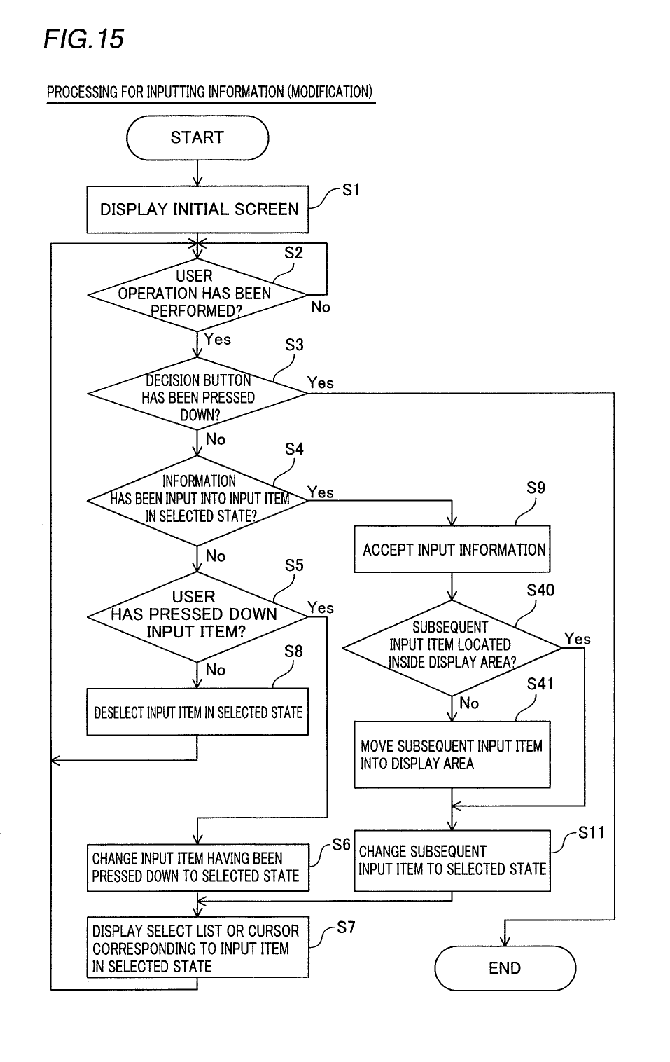

Processing for inputting information according to a modification of the aforementioned first embodiment is now described with reference to FIG. 15. In this processing for inputting information according to the modification of the first embodiment, steps S1 to S9 and S11 are similar to those in the aforementioned first embodiment, and hence the description is omitted. A CPU 5 determines whether or not a subsequent input item is located inside a display area at a step S40 after accepting input information at the step S9. If determining that the subsequent input item is located inside the display area, the CPU 5 advances to the step S11 and changes the subsequent input item to a selected state. In other words, the subsequent input item is not moved but changed to the selected state if the subsequent input item is located inside the display area. If determining that the subsequent input item is located outside the display area, on the other hand, the CPU 5 moves the subsequent input item into the display area at a step S41, and thereafter changes the subsequent input item to the selected state at the step S11.

While the processing performed by the CPU serving as the control portion is described with the flow-driven flowchart in which processing is performed in order along the lines of a processing flow for convenience of description in each of the aforementioned first and second embodiments, the present invention is not restricted to this. In the present invention, the processing performed by the control portion may alternatively be event-driven processing performed on a one-event basis. In this case, the processing performed by the control portion may be completely event-driven processing or a combination of event-driven processing and flow-driven processing.

What is claimed is:

1. An information terminal comprising:
a display portion displaying a plurality of input items to accept information from a user; and
a control portion displaying a subsequent input item to an input item into which information has been input in a selected state where the user can input information on said display portion on the basis of a prescribed order of said plurality of input items when the user inputs the information into said input item in the selected state where information can be input, of said plurality of input items.

2. The information terminal according to claim 1, wherein
said control portion is so formed as to display said subsequent input item in the selected state where the user can input information on said display portion by displaying a graphical user interface element allowing the user to select or enter information corresponding to said subsequent input item when the user inputs the information into said input item in the selected state, of said plurality of input items.

3. The information terminal according to claim 2, wherein
said control portion is so formed as to display said subsequent input item in the selected state where the user can input information on said display portion by moving said subsequent input item into a display area of said display portion if said subsequent input item is located outside said display area of said display portion, when the user inputs the information into said input item in the selected state, of said plurality of input items.

4. The information terminal according to claim 2, wherein
said graphical user interface element allowing the user to select the information corresponding to said subsequent input item includes a select list of the information corresponding to said subsequent input item, and
said graphical user interface element allowing the user to enter the information corresponding to said subsequent input item includes a cursor allowing the user to enter character information corresponding to said subsequent input item.

5. The information terminal according to claim 2, wherein
said control portion is so formed as to display a graphical user interface element allowing the user to select or enter information corresponding to an input item having previously been in the selected state on a second display area different from a first display area displaying said plurality of input items and display said subsequent input item in the selected state where the user can input information on said display portion, when the user inputs the information into said input item in the selected state, of said plurality of input items.

6. The information terminal according to claim 5, wherein
said control portion is so formed as to display said graphical user interface element allowing the user to select or enter the information corresponding to said subsequent input item on a third display area different from said first display area and said second display area when the user inputs the information into said input item in the selected state, of said plurality of input items.

7. The information terminal according to claim 6, wherein
said second display area and said third display area are arranged adjacent to each other.

8. The information terminal according to claim 5, wherein
said control portion is so formed as to accept change in information having been input into said input item having previously been in the selected state when the user inputs information through said graphical user interface element corresponding to said input item having previously been in the selected state, displayed on said second display area.

9. The information terminal according to claim 5, wherein
information other than information having been selected by the user is selectably displayed in said graphical user interface element allowing the user to select the information corresponding to said input item having previously been in the selected state, displayed on said second display area.

10. The information terminal according to claim 1, wherein
said control portion is so formed as to move said subsequent input item to a vicinity of a central portion of a display area displaying said plurality of input items when the user inputs the information into said input item in the selected state, of said plurality of input items.

11. The information terminal according to claim 1, wherein
said control portion is so formed as to display said subsequent input item in the selected state where the user can input information and in a state distinguishable from other input items on said display portion when the user inputs the information into said input item in the selected state, of said plurality of input items.

12. The information terminal according to claim 4, wherein
said control portion is so formed as to display said select list on said display portion such that said select list overlaps a display area of said subsequent input item.

13. A portable information terminal comprising:
a display portion having such a size that part of a plurality of input items to accept information from a user can be displayed on a same screen; and
a control portion displaying a subsequent input item to an input item into which information has been input in a selected state where the user can input information on said display portion on the basis of a prescribed order of said plurality of input items when the user inputs the information into said input item in the selected state where information can be input, of said plurality of input items.

14. The portable information terminal according to claim 13, wherein
said control portion is so formed as to display said subsequent input item in the selected state where the user can input information on said display portion by displaying a graphical user interface element allowing the user to select or enter information corresponding to said subsequent input item when the user inputs the information into said input item in the selected state, of said plurality of input items.

15. The portable information terminal according to claim 14, wherein
said control portion is so formed as to display said subsequent input item in the selected state where the user can input information on said display portion by moving said subsequent input item into a display area of said display portion if said subsequent input item is located outside said display area of said display portion, when the user inputs the information into said input item in the selected state, of said plurality of input items.

16. The portable information terminal according to claim 14, wherein
said graphical user interface element allowing the user to select the information corresponding to said subsequent input item includes a select list of the information corresponding to said subsequent input item, and
said graphical user interface element allowing the user to enter the information corresponding to said subsequent input item includes a cursor allowing the user to enter character information corresponding to said subsequent input item.

17. The portable information terminal according to claim 14, wherein
said control portion is so formed as to display a graphical user interface element allowing the user to select or enter information corresponding to an input item having previously been in the selected state on a second display area different from a first display area displaying said plurality of input items and display said subsequent input item in the selected state where the user can input information on said display portion, when the user inputs the information into said input item in the selected state, of said plurality of input items.

18. The portable information terminal according to claim 17, wherein
said control portion is so formed as to display said graphical user interface element allowing the user to select or enter the information corresponding to said subsequent input item on a third display area different from said first display area and said second display area when the user inputs the information into said input item in the selected state, of said plurality of input items.

19. The portable information terminal according to claim 17, wherein
information other than information having been selected by the user is selectably displayed in said graphical user interface element allowing the user to select the information corresponding to said input item having previously been in the selected state, displayed on said second display area.

20. The portable information terminal according to claim 13, wherein
said control portion is so formed as to move said subsequent input item to a vicinity of a central portion of a display area displaying said plurality of input items when the user inputs the information into said input item in the selected state, of said plurality of input items.
